(19) United States
(12) Patent Application Publication
(10) Pub. No.: US 2011/0216095 A1
(43) Pub. Date: Sep. 8, 2011

(54) Methods, Devices, and Computer Program Products Providing Multi-Touch Drag and Drop Operations for Touch-Sensitive User Interfaces

(76) Inventor: Tobias Rydenhag, Malmo (SE)

(21) Appl. No.: 12/717,424

(22) Filed: Mar. 4, 2010

(51) Int. Cl. G06T 3/20; G06F 3/033; G06F 3/048

(52) U.S. Cl. 345/676; 715/863; 715/825; 715/830; 345/173

(57) ABSTRACT

A method of operating an electronic device including a touch-sensitive interface and a display screen. A method of operating such an electronic device may include detecting primary and secondary contacts on the touch-sensitive interface, and detecting movement of the primary contact on the touch-sensitive interface. Responsive to detecting movement of the primary contact and detecting the secondary contact, a graphical element presented on the display screen may be moved from a first location on the display screen to a second location on the display screen. Related devices are also discussed.

### FIELD OF THE INVENTION

The present invention relates to electronic devices, and more particularly, to electronic devices with touch-sensitive user interfaces and related methods and computer program products.

### BACKGROUND

Electronic devices, such as handheld and/or desktop computing devices, are continuing to evolve to provide increasing functionality. Consumers may now select from a wide array of handheld and/or desktop electronic devices, such as cellular mobile terminals, personal digital assistants (PDAs), netbook computers, laptop computers, and desktop computers. Such devices typically provide tactile, audio, and/or video user interfaces. For example, a mobile terminal may include a touch-screen display, keypad, speaker and microphone, which together support telephony functions. These components may also support multimedia, gaming and other applications.

Producers of such devices constantly strive to provide new audio and visual interfaces to enhance user experience and, thus, garner greater market share. For example, handheld and desktop devices have been provided with touch-screen displays that may allow for user inputs using a user input object, such a finger, thumb, or stylus. Such a touch-screen display may allow a user to manipulate graphical information presented on the touch-screen using touch input on the touch-screen. The user, for example, may scroll and/or pan through graphical information by dragging a finger across the touch-screen in the direction of the desired scroll and/or pan.

### SUMMARY

According to some embodiments of the present invention, an electronic device may include a touch-sensitive interface and a display screen. Methods of operating such an electronic device may include detecting primary and secondary contacts on the touch-sensitive interface, and detecting movement of the primary contact on the touch-sensitive interface. Responsive to detecting movement of the primary contact and detecting the secondary contact, a graphical element presented on the display screen may be moved from a first location on the display screen to a second location on the display screen.

The graphical element may be a first graphical element, and moving the graphical element may include changing a position of the first graphical element presented on the display screen relative to a second graphical element presented on the display screen. For example, moving the first graphical element may include moving the first graphical element while maintaining a same location of the second graphical element presented on the display screen. The first and second graphical elements may be first and second elements of a list (e.g., a contacts list, a playlist, a list of photos etc.), and moving the first graphical element may include changing an order of the list, or the first and second graphical elements may be first and second icons (e.g., application icons, file icons, thumbnails of photos, etc.), and moving the first icon may include changing a position of the first icon relative to the second icon.

In addition, movement of the third contact on the touch-sensitive interface may be detected without detecting other contact on the touch-sensitive interface, and translating positions of a plurality of graphical elements presented on the display screen may be translated without changing relative positions of the plurality of graphical elements presented on the display screen responsive to detecting movement of the third contact without detecting other contact on the touch-sensitive interface. Such translation may be used to provide scrolling and/or panning of the graphical output provided on the display screen.

The touch-sensitive interface and the display screen may be integrated to provide a touch-screen display, or the touch-sensitive interface may be separate from the display screen. Detecting the primary contact may include detecting the primary contact at a first location on the touch-sensitive interface, detecting movement of the primary contact may include detecting movement of the primary contact from the first location on the touch-sensitive interface to a second location on the touch-sensitive interface, and the first and second locations on the display screen may respectively correspond to the first and second locations on the touch-sensitive interface.

Detecting the primary and secondary contacts may include detecting contacts of respective primary and secondary input objects on the touch-sensitive interface. Moving the graphical element may include moving the graphical element responsive to detecting movement of the primary contact while detecting the secondary contact. Moving the graphical element may include moving the graphical element responsive to detecting movement of the primary contact after detecting the primary and secondary contacts overlapping in time. Moreover, detecting the primary contact on the touch-sensitive interface may precede detecting the secondary contact on the touch-sensitive interface so that the primary contact is identified as the first of the two contacts that are overlapping in time, or detecting the secondary contact on the touch-sensitive interface may precede detecting the primary contact on the touch-sensitive interface so that the primary contact is identified at the second of the two contacts that are overlapping in time. According to still other embodiments of the present invention, the primary contact may be identified as the first of the two contacts (overlapping in time) to move.

According to other embodiments of the present invention, an electronic device may include a touch-sensitive interface, a display screen, and a processor coupled to the touch-sensitive interface and to the display screen. The processor may be configured to detect primary and secondary contacts on the touch-sensitive interface and to detect movement of the primary contact on the touch-sensitive interface. The processor may be further configured to move a graphical element presented on the display screen from a first location on the display screen to a second location on the display screen responsive to detecting movement of the primary contact and detecting the secondary contact.

The graphical element may include a first graphical element, and moving the graphical element may include changing a position of the first graphical element presented on the display screen relative to a second graphical element presented on the display screen. Moving the first graphical element may include moving the first graphical element while maintaining a same location of a second graphical element presented on the display screen. The first and second graphical elements may be first and second elements of a list (e.g., a contacts list, a play list, a list of photos, etc.), and moving the first graphical element may include changing an order of the list. The first and second graphical elements may be first and second icons (e.g., application icons, file icons, thumbnails of photos, etc.), and moving the first icon may include changing a position of the first icon relative to the second icon.

The processor may be further configured to detect a third contact on the touch-sensitive interface, to detect movement of the third contact on the touch-sensitive interface without detecting other contact on the touch-sensitive interface, and to translate positions of a plurality of graphical elements presented on the display screen without changing relative positions of the plurality of graphical elements presented on the display screen responsive to detecting movement of the third contact without detecting other contact on the touch-sensitive interface. Accordingly, a single touch input may be used to scroll and/or pan.

The touch-sensitive interface and the display screen may be integrated to provide a touch-screen display, or the touch-sensitive interface may be separate from the display screen. Detecting the primary contact may include detecting the primary contact at a first location on the touch-sensitive interface, detecting movement of the primary contact may include detecting movement of the primary contact from the first location on the touch-sensitive interface to a second location on the touch-sensitive interface, and the first and second locations on the display screen may respectively correspond to the first and second locations on the touch-sensitive interface.

Moving the graphical element may include moving the graphical element responsive to detecting movement of the primary contact while detecting the secondary contact, and/or moving the graphical element may include moving the graphical element responsive to detecting movement of the primary contact after detecting the primary and secondary contacts overlapping in time.

Detecting the primary contact on the touch-sensitive interface may precede detecting the secondary contact on the touch-sensitive interface so that the primary contact is identified as the first of the two contacts that are overlapping in time, or detecting the secondary contact on the touch-sensitive interface may precede detecting the primary contact on the touch-sensitive interface so that the primary contact is identified at the second of the two contacts that are overlapping in time. According to still other embodiments of the present invention, the primary contact may be identified as the first of the two contacts (overlapping in time) to move.

According to still other embodiments of the present invention, a computer program product may be provided for operating an electronic device including a touch-sensitive interface and a display screen. The computer program product may include a computer readable storage medium having computer readable program code embodied in the medium. The computer readable program code may include computer readable program code that, when executed, detects primary and secondary contacts on the touch-sensitive interface, and detects movement of the primary contact on the touch-sensitive interface. The computer readable program code may further include computer readable program code that, when executed, moves a graphical element presented on the display screen from a first location on the display screen to a second location on the display screen responsive to detecting movement of the primary contact and detecting the secondary contact.

### BRIEF DESCRIPTION OF THE DRAWINGS

FIG. 1 is a block diagram illustrating electronic devices including touch-sensitive interfaces according to some embodiments of the present invention.

FIGS. 2A and 2B illustrate examples of mobile electronic devices including touch-sensitive interfaces according to some embodiments of the present invention.

FIGS. 3A to 3G and 4A to 4H are representations of graphical outputs illustrating operations of moving graphical elements according to some embodiments of the present invention.

FIG. 5 is a flow chart illustrating operations of moving graphical elements according to some embodiments of the present invention.

### DETAILED DESCRIPTION OF EMBODIMENTS

The present invention now will be described more fully hereinafter with reference to the accompanying figures, in which embodiments of the present invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” (and variants thereof) when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” to another element/step (and variants thereof), it can be directly responsive to the other element/step, or intervening elements/steps may be present. In contrast, when an element/step is referred to as being “directly responsive” to another element/step (and variants thereof), there are no intervening elements/steps present. As used herein the term “and/or” includes any and all combinations of one or more of the associated listed items and may be abbreviated as “/”.

It will be understood that, although the terms first, second, third, etc. may be used herein to describe various elements, these elements should not be limited by these terms. These terms are only used to distinguish one element from another.

The present invention is described below with reference to block diagrams and/or flowchart illustrations of methods, apparatus (systems and/or devices) and/or computer program products according to embodiments of the invention. It is understood that a block of the block diagrams and/or flowchart illustrations, and combinations of blocks in the block diagrams and/or flowchart illustrations, can be implemented by hardware and/or in software (including firmware, resident software, micro-code, etc.), referred to herein as “circuitry” or “circuit”. For example, some of the functionality may be implemented in computer program instructions that may be provided to a processor of a general purpose computer, special purpose computer, digital signal processor and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a processor of the computer and/or other programmable data processing apparatus to function in a particular manner, such that the instructions stored in the computer-readable memory produce an article of manufacture including instructions which implement the function/act as specified in the block diagrams and/or flowchart block or blocks. The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks.

A computer-usable or computer-readable medium may be, for example but not limited to, an electronic, magnetic, optical, electromagnetic or semiconductor system, apparatus or device. More specific examples (a non-exhaustive list) of the computer-readable medium would include the following: a portable computer diskette, a random access memory (RAM), a read-only memory (ROM), an erasable programmable read-only memory (EPROM or Flash memory), and a portable optical and/or magnetic media, such as a flash disk or CD-ROM.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Although some of the diagrams include arrows on communication paths to show a primary direction of communication, it is to be understood that communication may occur in the opposite direction to the depicted arrows.

For purposes of illustration and explanation only, various embodiments of the present invention are described herein primarily in the context of mobile terminals including touch-screen displays; however, it will be understood that the present invention is not limited to such embodiments and may be embodied generally in any system that employs a touch-sensitive user interface. As used herein, a “touch-sensitive interface” may refer to an electronic input device, such as a touch-screen or touchpad, that is configured to detect touch and/or motion-based user inputs on an area within which the sensor is bounded. As such, touch-sensitive interfaces as described herein do not encompass button, toggle, or other physical switch-type interfaces. Although described herein primarily with reference to capacitance-based touch-sensitive interfaces, it is to be understood that some embodiments of the present invention may employ one or more other touch-sensing technologies, such as resistance, surface acoustic wave (SAW), infrared, strain gauge, optical imaging, dispersive signal, acoustic pulse imaging, frustrated total internal reflection, and/or other touch-sensing technologies.

As used herein, “scrolling” and/or “panning” refers to sliding graphical information (e.g., text, images video, etc.) across a display screen in any direction (e.g., from top-to-bottom, bottom-to-top, left-to-right, right-to-left, diagonally, etc.). “Scrolling” and/or “panning” does not change the layout of the graphical information or relative positions of graphical elements thereof, but rather, incrementally moves portions of a larger image into and/or out of the user's view on the display screen, where the entirety of the larger image is not viewable on the display screen at a present level of magnification. Also, a “scrolling input” and/or a “panning input” refers to movement of a user input object (e.g., dragging a finger) on a touch-sensitive interface in any direction (e.g., from top-to-bottom, bottom-to-top, left-to-right, right-to-left, diagonally, etc.) between the aforementioned directions.

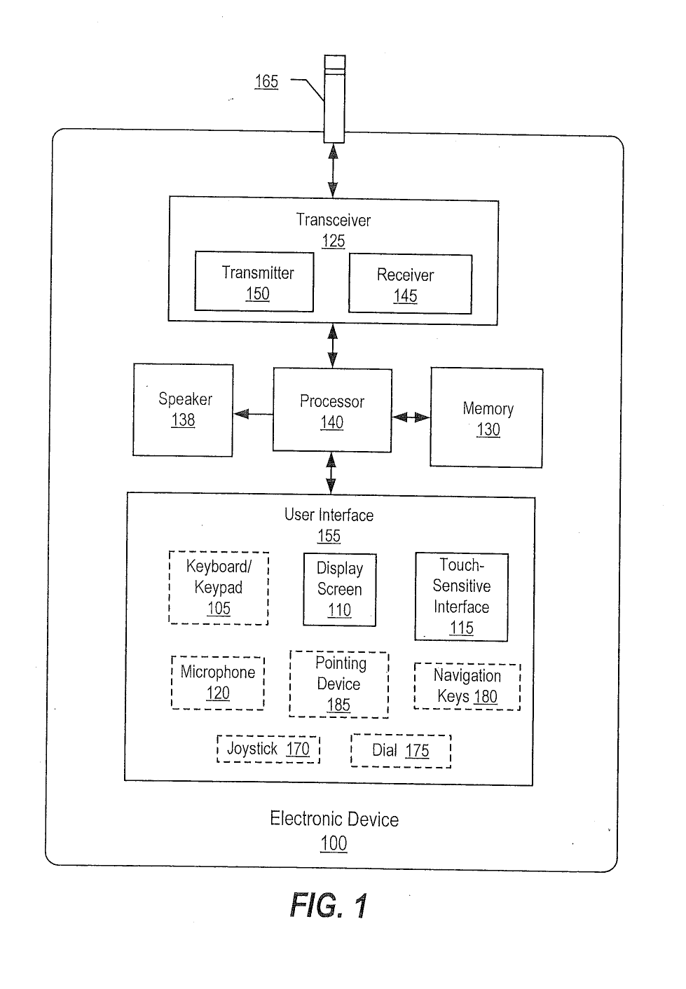

FIG. 1 is a block diagram illustrating an electronic device including a touch-sensitive interface in accordance with some embodiments of the present invention. Referring now to FIG. 1, electronic device 100 may include transceiver 125, memory 130, speaker 138, processor 140, and user interface 155. Transceiver 125 may include transmitter circuit 150 and receiver circuit 145 that cooperate to transmit and receive radio frequency signals to and from base station transceivers via antenna 165. The radio frequency signals transmitted between electronic device 100 and the base station transceivers may include both traffic and control signals (e.g., paging signals/messages for incoming calls), which are used to establish and maintain communication with another party or destination. The radio frequency signals may also include packet data information, such as, for example, cellular digital packet data (CDPD) information. In addition, transceiver 125 may include an infrared (IR), Bluetooth, and/or Wi-Fi transceiver configured to transmit/receive signals to/from other electronic devices.

Memory 130 may represent a hierarchy of memory that may include volatile and/or non-volatile memory, such as removable flash, magnetic, and/or optical rewritable non-volatile memory. Memory 130 may be configured to store several categories of software, such as an operating system, applications programs, and input/output (I/O) device drivers. The operating system may control the management and/or operation of system resources and may coordinate execution of programs by processor 140. The I/O device drivers typically include software routines accessed through the operating system by the application programs to communicate with input/output devices, such as those included in user interface 155 and/or other components of memory 130.

Processor 140 is coupled to transceiver 125, memory 130, speaker 138, and user interface 155. Processor 140 may be, for example, a commercially available or custom microprocessor that is configured to coordinate and manage operations of transceiver 125, memory 130, speaker 138, and/or user interface 155.

User interface 155 may include microphone 120, display screen 110 (such as a liquid crystal display), touch-sensitive interface 115, joystick 170, keyboard/keypad 105, dial 175, directional navigation key(s) 180, and/or pointing device 185 (such as a mouse, trackball, etc.). However, depending on functionalities offered by electronic device 100, additional and/or fewer elements of user interface 155 may actually be provided. For example, touch-sensitive interface 115 may be implemented as an overlay on display screen 110 to provide a touch-sensitive display screen (or “touch-screen”) in some embodiments. More generally, while particular functionalities are shown in particular blocks by way of illustration, functionalities of different blocks and/or portions thereof may be combined, divided, and/or eliminated. Embodiments of the present invention may be used in any electronic device that includes a touch-sensitive interface, such as personal digital assistants (PDAs), mobile phones, laptop computers, desktop computers, and the like. Moreover, embodiments of the present invention may be implemented in devices using any operating system such as Windows, Vista, Linux, WebOS, PalmOS, iPhoneOS, Android, etc.

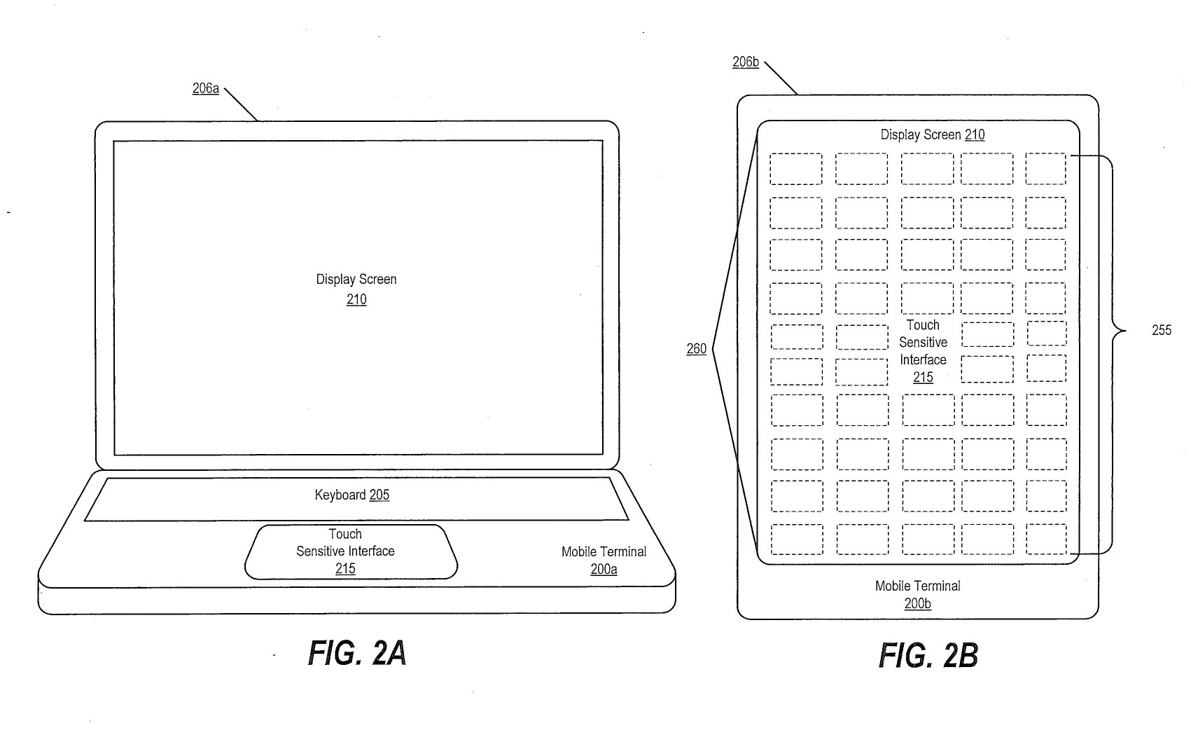

FIGS. 2A and 2B illustrate examples of configurations of electronic devices (such as the electronic device 100 of FIG. 1) that provide multi-touch drag and drop move operations in accordance with some embodiments of the present invention. As such, user interfaces and/or other elements of FIGS. 2A and/or 2B may be similar to user interface 155 and/or other elements of FIG. 1. In particular, FIG. 2A illustrates mobile terminal 200a (shown as a laptop computer) where the user interface is implemented as a separate keyboard 205, display screen 210, and touch-sensitive interface 215 in housing 206a, while FIG. 2B illustrates mobile terminal 200b (e.g., a mobile phone, handheld/tablet computer, etc.) where the user interface is implemented as display screen 210 underlying touch-sensitive interface 215 to provide touch-screen display 260 in housing 206b. Display screen 210 and touch-sensitive interface 215 are thus integrated as a touch-screen display 260.

Referring now to FIGS. 2A and 2B, touch-sensitive interface 215 may include an array of sensors 255 that are operable to receive an input from a user input object and generate a touch signal in response to the input. In particular, the array of touch sensors 255 may be operable to detect touch and/or directional movements of a user input object, such as a stylus or digit of a human hand (i.e., a thumb or finger) on touch-sensitive interface 215. The touch signal generated by sensors 255 may also be used to identify corresponding location(s) (e.g., coordinate locations) of the touch-sensitive interface 215 at which the input is received (e.g., where a user is touching touch-sensitive interface 215), distances of movement of the user input object on touch-sensitive interface 215, and/or speed of movement of the user input object. In each of FIGS. 2A and 2B, user interface elements (e.g., keyboard 205, display screen 210, and touch-sensitive user interface 215 of FIG. 2A, and display screen 210 and touch-sensitive interface 215 of touch-screen display 260 of FIG. 2B) may be provided in user interface 155 of FIG. 1 and may be coupled to processor 140 as discussed above with respect to FIG. 1.

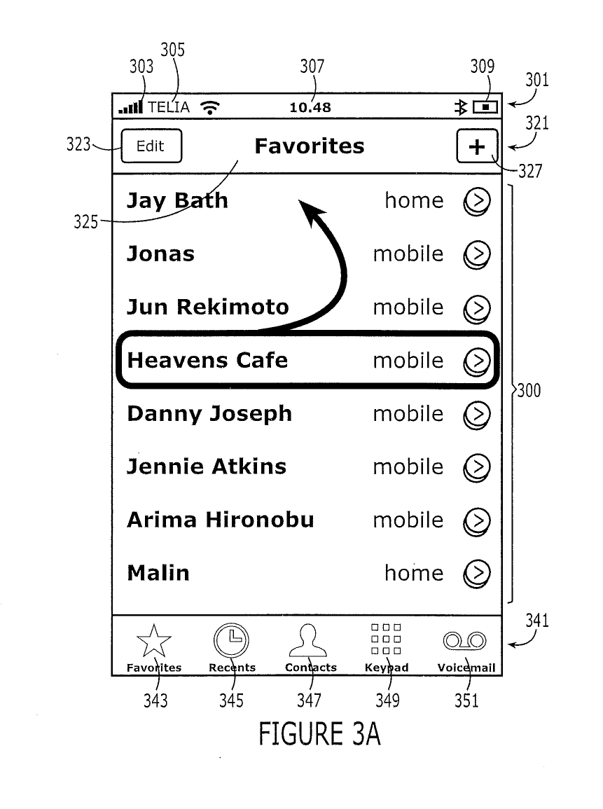

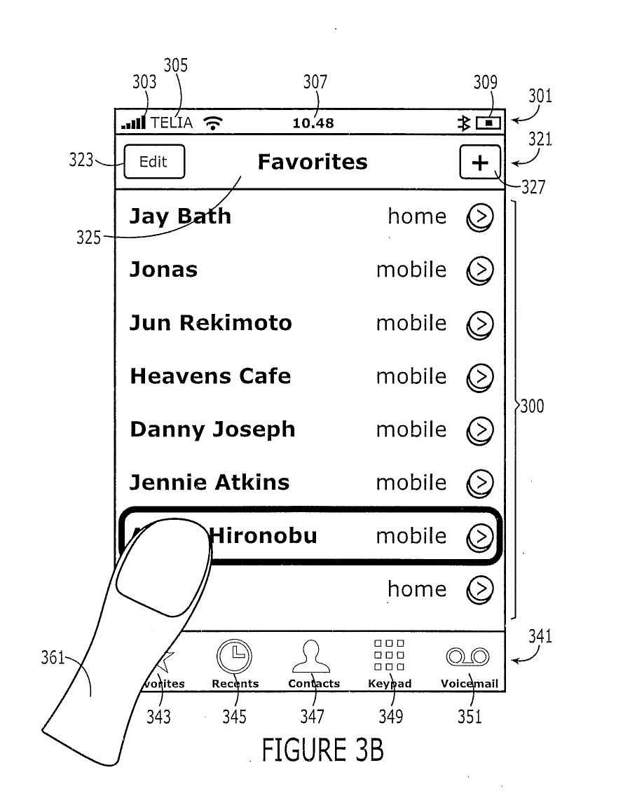

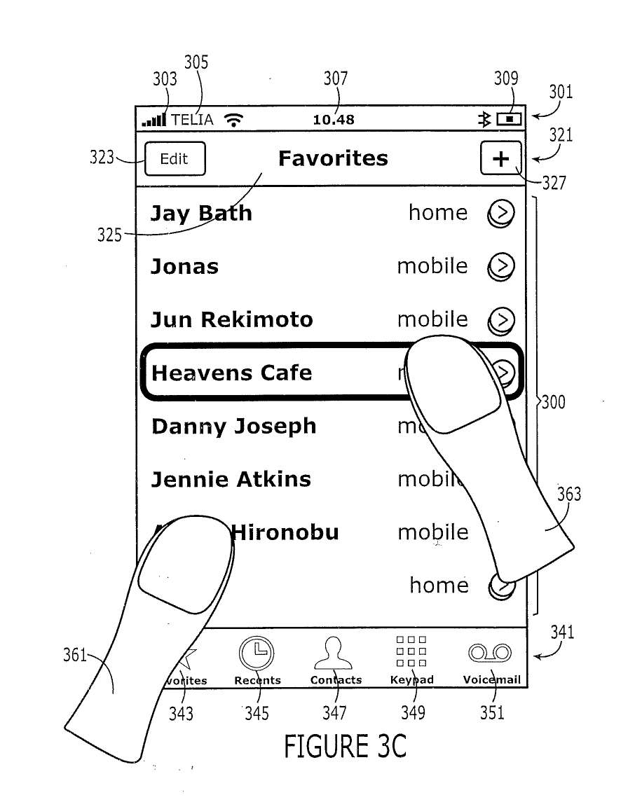

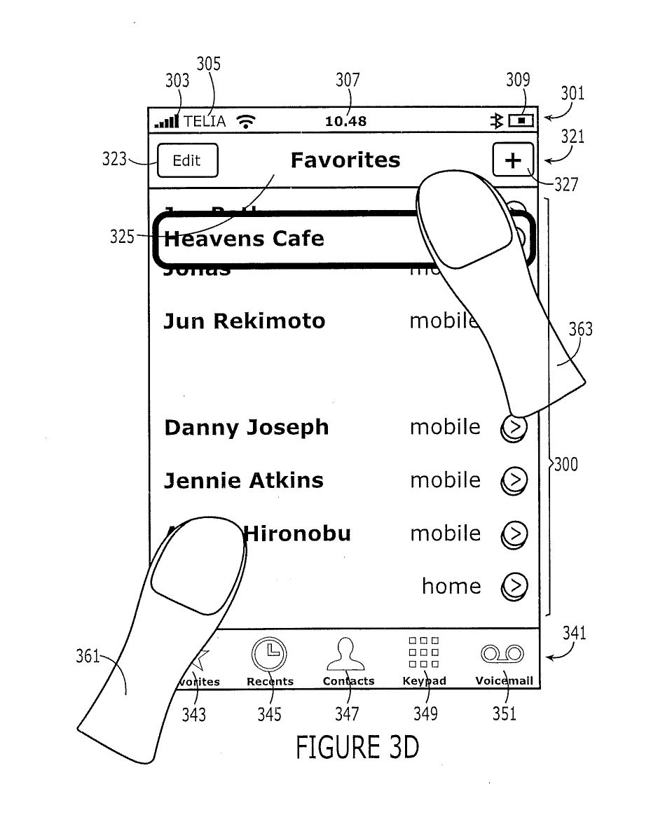

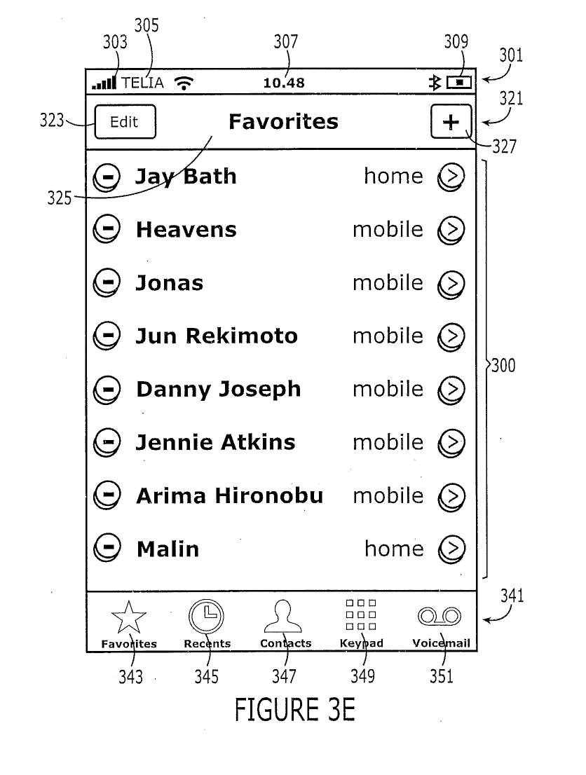

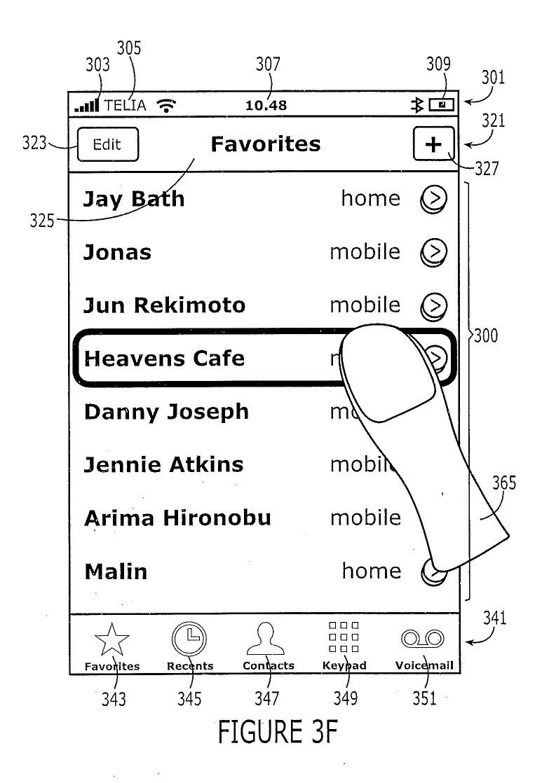

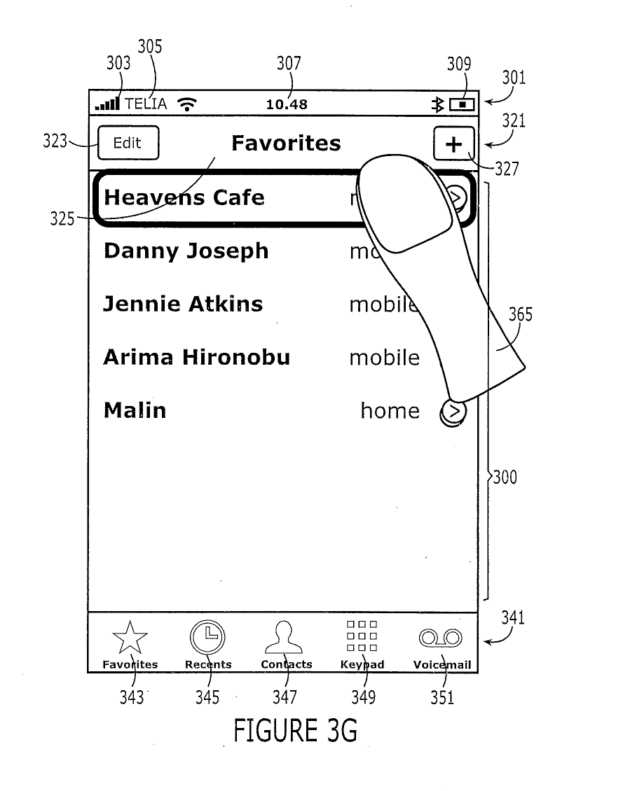

Embodiments of the present invention will now be discussed in greater detail with respect to FIGS. 3A to 3G which illustrate graphical outputs provided on touch-screen display 260 of FIG. 2B. As shown in FIG. 3A, for example, a plurality of graphical elements may be presented as a list 300 on the touch-screen display to provide a portion of a list of contacts. In the example of FIGS. 3A to 3F, a separate graphical element may be used to represent each contact (e.g., for “Jay Bath”, “Jonas”, “Jun Rekimoto”, “Heavens Cafe”, “Danny Joseph”, “Jennie Atkins”, “Arima Hironobu”, “Malin”, etc.) in the list 300. The list 300 may include additional contacts (e.g., before “Jay Bath” and/or after “Malin”) that are not shown in FIG. 3A, but that may be accessed by scrolling up or down. While a list of contacts is discussed by way of example, embodiments of the present invention may be implemented with other lists such as playlists, task lists, lists of photos, etc., and/or with other arrangements of other graphical elements.

The touch-screen display of FIGS. 3A to 3G may also provide a status bar 301 across the top, a title bar 321 below the status bar, and/or a functions bar 341 across the bottom. The status bar 301 may include (from left to right) reception bars 303 indicating a signal strength, an identification 305 of a service provider (“TELIA”), the time 307, and a battery indicator 309 providing a battery charge status. The title 321 bar may include (from left to right) a graphic edit button 323, a title 325 (e.g., “Favorites”), and a graphic button 327 (e.g., “+”) used to add a contact. The functions bar 341 may include graphic buttons 343, 345, 347, 349, and 351 used to quickly access (from left to right) “Favorites”, “Recent”, “Contacts”, “Keypad”, and “Voicemail” contact functionalities.

A user may wish to change an order of the list using a drag and drop move operation according to some embodiments of the present invention. For example, the user may wish to change an order of the list by moving the graphical element for the contact “Heavens Cafe” to a position between the graphical elements for the contacts “Jay Bath” and “Jonas” as indicated by the arrow of FIG. 3A. According to embodiments of the present invention, a drag and drop move operation may be performed by contacting a secondary user input object 361 (e.g., a left thumb) anywhere on the touch-screen display as shown in FIG. 3B, and contacting a primary user input object (e.g., a right thumb) 363 on the graphical element to be moved as shown in FIG. 3C. Responsive to contact by the primary user input object 363, the graphical element may be highlighted to indicate selection thereof. Then the primary user input object 363 (e.g., the right thumb) is moved (dragged) across the touch-screen display (while maintaining contact) to move the selected graphical element (e.g., “Heavens Cafe”) to a desired position as shown in FIG. 3D. Once the graphical element has been moved to the desired position, the primary user input object 363 (e.g., the right thumb) can be removed from the touch-screen display (withdrawing contact) to drop the graphical element into the new position and complete the operation as shown in FIG. 3E. Accordingly, a position of the selected graphical element (e.g., the contact listing for “Heavens Cafe”) presented on the display screen may be changed relative to other graphical elements (e.g., contact listings for “Jay Bath”, “Jonas”, “Jun Rekimoto”, “Danny Joseph”, “Jennie Atkins”, “Arima Hironobu” and/or “Malin”) presented on the display screen thereby changing an order of the list. The contact listing for “Heavens Cafe” may thus be moved from a position between contact listings for “Jun Rekimoto” and “Danny Joseph” to a position between contact listings for “Jonas” and “Jay Bath”.

By using two input objects in contact with the touch-screen display to perform the drag and drop operation as discussed above, a drag and drop operation may be easily distinguished from a scroll operation. Accordingly, the secondary contact (e.g., provided by the left thumb) holds the list in place to prevent scrolling/panning during the drag and drop move operation, and the primary contact (e.g., provided by the right thumb) moves the selected element of the list. Stated in other words, the secondary contact 361 may be used to hold the list in place thereby preventing scrolling and enabling the drag and drop functionality.

In contrast, if contact of only a single user input object (e.g., a right thumb) 365 is provided on the graphical element (e.g., “Heavens Cafe”) as shown in FIG. 3F and then dragged, positions of a plurality of graphical elements presented on the display screen may be translated without changing relative positions of the plurality of graphical elements presented on the display screen, as shown in FIG. 3G. Accordingly, contact of a single user input object may be used to perform a scroll, pan, and/or selection operation, and contact of two user input objects (with contact overlapping in time) may be used to perform a drag and drop move operation according to some embodiments of the present invention.

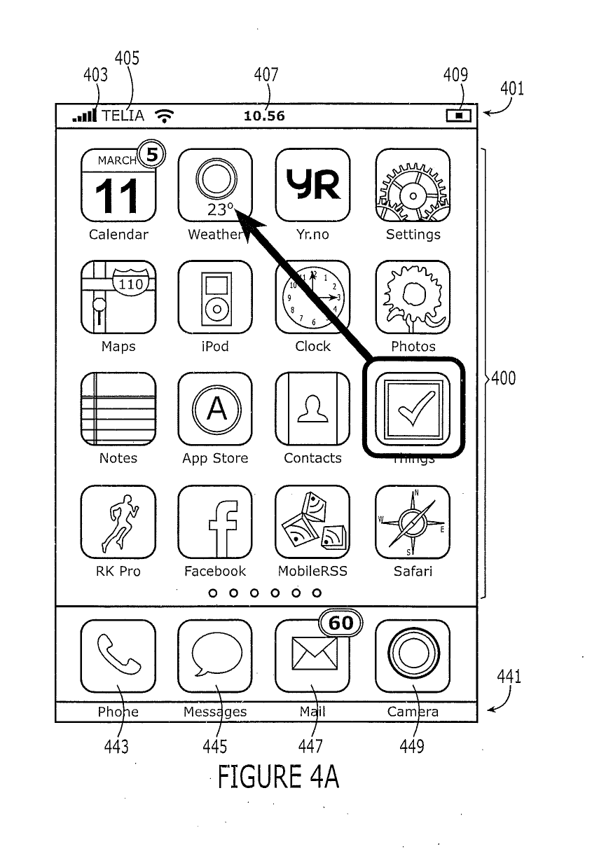

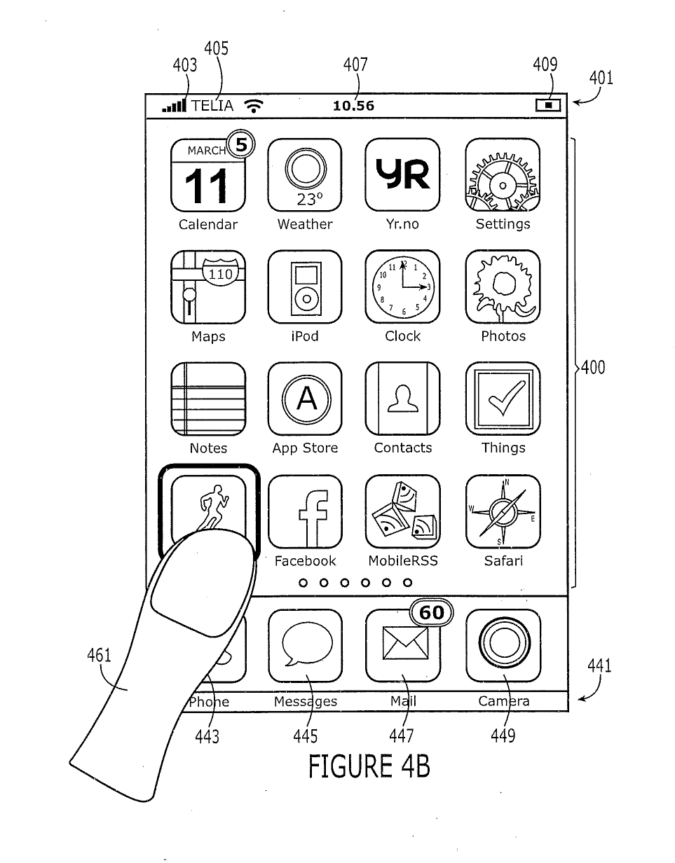

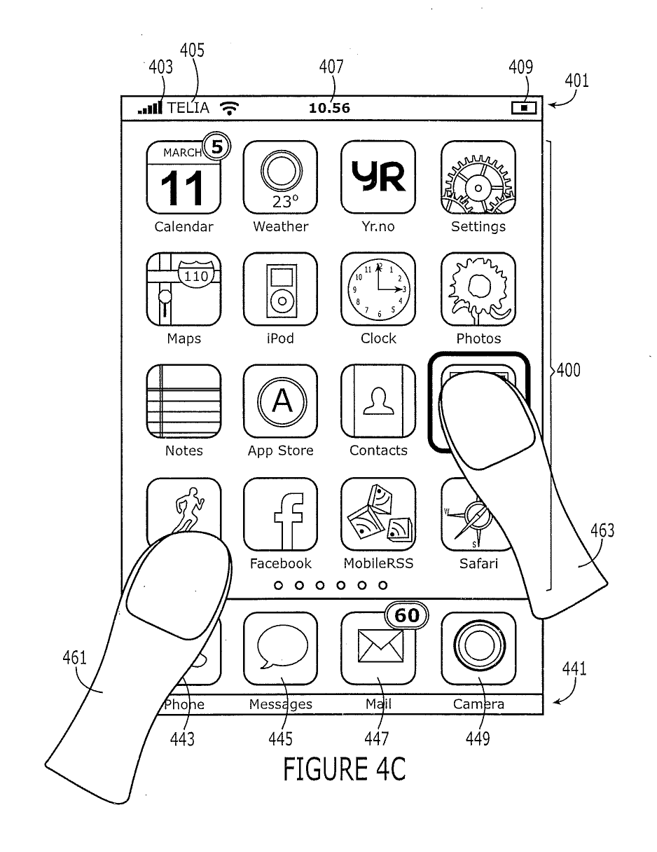

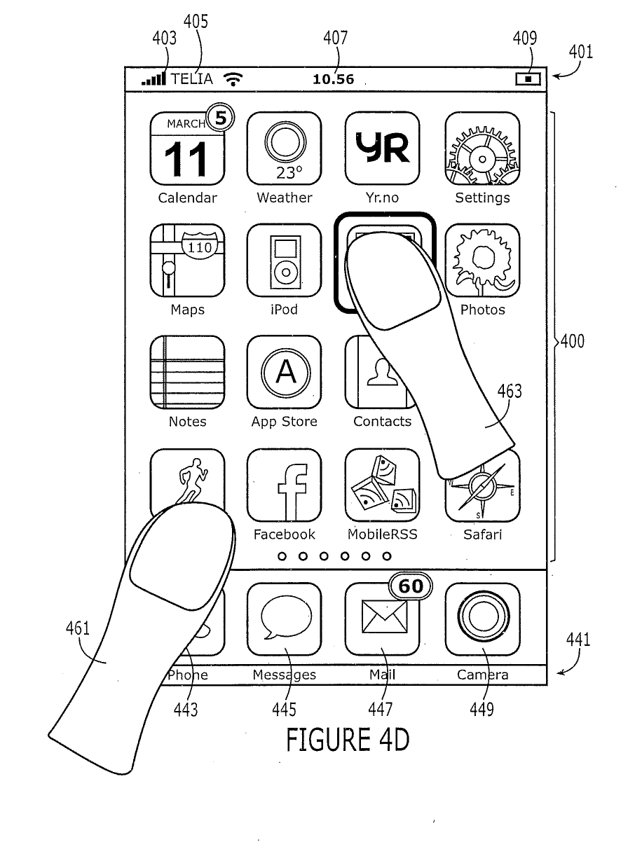

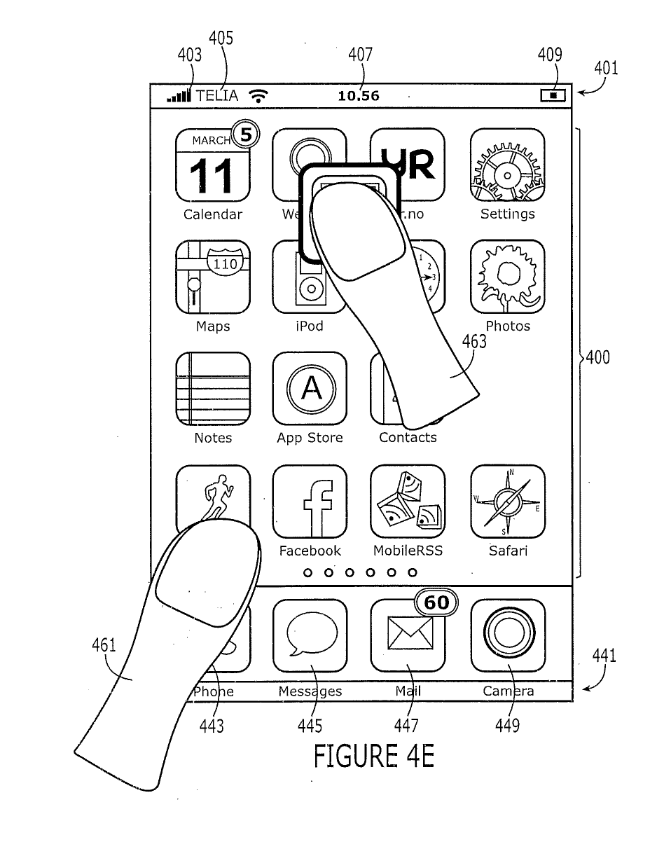

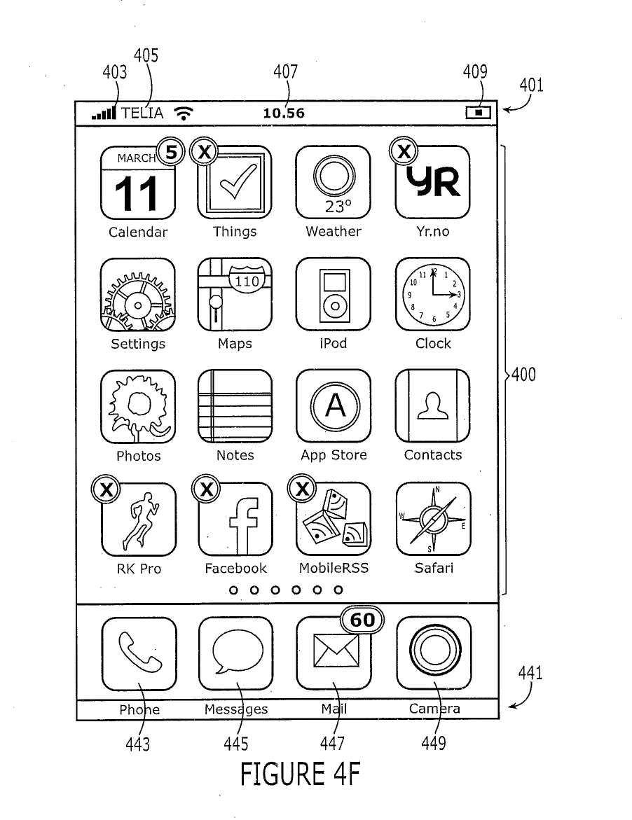

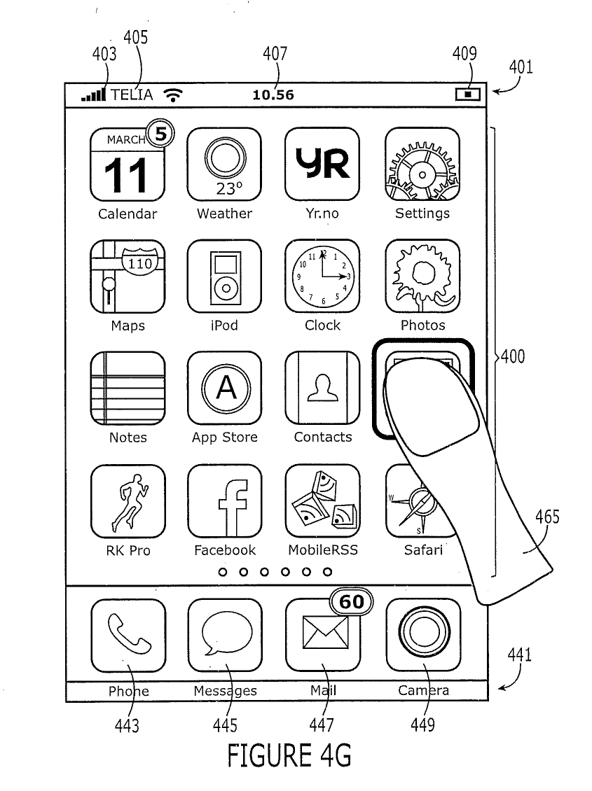

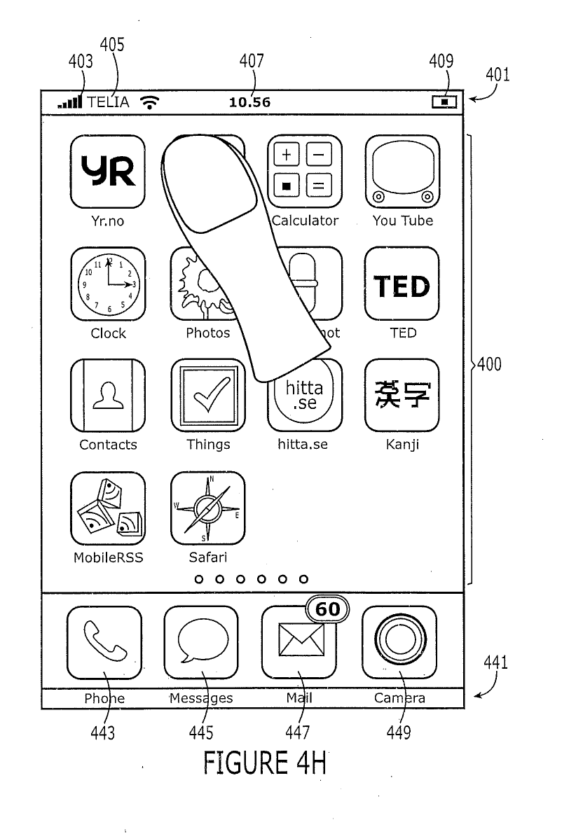

Further embodiments of the present invention will now be discussed in greater detail with respect to FIGS. 4A to 4H which illustrate graphical outputs provided on touch-screen display 260 of FIG. 2B. As shown in FIG. 4A, for example, a plurality of graphical elements may be presented on the touch-screen display to provide a portion of an array, such as application tray 400, with icons representing different applications, functions, files, thumbnails of photos, etc, arranged in a grid. By way of example, the graphical output of FIG. 4A includes icons for “Calendar”, “Weather”, “Yr. No”, “Settings”, “Maps”, “iPod”, “Clock”, Photos”, “Notes”, “App Store”, “Contacts”, “Things”, “RK Pro”, “Facebook”, “MobileRSS”, and “Safari” applications. The application tray may include additional icons not shown in FIG. 4A that may be accessed by scrolling/panning up, down, left, right, and/or diagonally. While an application tray of icons is discussed by way of example, embodiments of the present invention may be implemented with other arrangements of other graphical elements.

The touch-screen display of FIGS. 4A to 4H may also provide a status bar 401 across the top and a function bar 441 across the bottom. The status bar 401 may include (from left to right) reception bars 403 indicating a signal strength, an identification 405 of a service provider (“TELIA”), the time 407, and a battery indicator 409 providing a battery charge status. The function bar 441 may include graphic buttons 443, 445, 447, and 449 used to quickly access functionalities such as (from left to right) “Phone”, “Messages”, “Mail”, and “Camera”.

A user may wish to change an order of the icons in the tray using a drag and drop operation. For example, the user may wish to change an order of the icons in the tray by moving the icon “Things” to a position occupied by the icon “Weather” as indicated by the arrow of FIG. 4A. According to embodiments of the present invention, a drag and drop move operation may be performed by contacting a secondary user input object (e.g., a left thumb) 461 anywhere on the touch-screen display, as shown in FIG. 4B, and contacting a primary user input object (e.g., a right thumb) 463 on the graphical element to be moved as shown in FIG. 4C, and the icon “Things” may be highlighted to indicate selection thereof. Then, the primary user input object (e.g., the right thumb) 463 may be moved (dragged) across the touch-screen display (while maintaining contact) to move the selected icon (e.g., “Things”) to a desired position as shown in FIGS. 4D and 4E. Once the icon has been moved to the desired position, the primary user input object (e.g., the right thumb) 463 can be removed from the touch-screen display (withdrawing contact) to drop the graphical element into the new position and rearrange the other icons to thereby complete the operation as shown in FIG. 4F. Accordingly, a position of the selected icon (e.g., “Things”) presented on the display screen may be changed relative to other icons (e.g., “Calendar”, “Weather”, “Yr. No”, “Settings”, “Maps”, “iPod”, “Clock”, Photos”, “Notes”, “App Store”, “Contacts”, “RK Pro”, “Facebook”, “MobileRSS”, and/or “Safari”) thereby changing an order of the tray of application icons. In the example of FIGS. 4A to 4F, the icon “Things” may be moved from a position on the 3^{rd} row and 4^{th} column to a position on the 1st row and 2^{nd} column, and positions of the icons “Weather”, “Yr. No”, “Settings”, “Maps”, “iPod”, “Clock”, “Photos”, “Notes”, “App Store”, and “Contacts” may be shifted.

By using two input objects in contact with the touch-screen display to perform the drag and drop move operation as discussed above, a drag and drop move operation may be easily distinguished from a scroll or pan operation. Accordingly, the secondary contact (e.g., provided by the left thumb) 461 holds the application tray in place to prevent scrolling/panning during the drag and drop move operation, and the primary contact (e.g., provided by the right thumb) 461 moves the selected icon. Stated in other words, the secondary contact 461 may be used to hold the tray in place thereby preventing scrolling/panning and enabling the drag and drop functionality.

In contrast, if contact of only a single user input object (e.g., a right thumb) 465 is provided on the icon (e.g., “Things”) as shown in FIG. 4G and then dragged, positions of the icons presented on the display screen may be translated (e.g., scrolled or panned) laterally and/or an icon may be selected without changing relative positions of the plurality of icons presented on the display screen, as shown in FIG. 4H. Accordingly, a single user input object may be used to perform a scroll, pan, and/or selection operation, and contact of two user input objects (overlapping in time) may be used to perform a drag and drop move operation according to some embodiments of the present invention.

Processor 140 (coupled to the touch-screen display 260) may thus be configured to detect primary and secondary contacts of respective primary and secondary user input objects (e.g., right and left thumbs), as shown in FIGS. 3A-C and 4A-C, and to detect movement of the primary contact of the primary user input object (e.g., the right thumb), as shown in FIGS. 3C-3D and 4C-4E. Responsive to detecting movement of the primary contact and detecting the secondary contact, processor 140 may be configured to move the selected graphical element (e.g., list item, icon, etc.) from a first location on the touch-screen display 260 to a second location on the touch-screen display 260 as shown in FIGS. 3C-3E and 4C-4F. Processor 140 may use any number of algorithms to determine which contact is the primary contact used to select and move the graphical element to be moved.

According to some embodiments, the primary contact may be determined as the subsequent of two contacts overlapping in time, as discussed above with respect to FIGS. 3A-C and 4A-C, or the primary contact may be determined as the initial of two contacts overlapping in time. According to other embodiments, the primary and secondary contacts may be determined based on location on the touch-screen display, with a designated area being provided for the secondary contact so that order of initial contacts of time overlapping primary and secondary contacts does not matter, For example, a top, bottom, or side margin of the touch-screen display may be provided for the secondary contact (used to identify a drag and drop move operation), and a primary contact may be provided on a portion of the touch-screen display corresponding to the graphical element being selected for movement. According to yet other embodiments, the primary contact may be determined as the first of the two contacts to move after the two contacts (overlapping in time) have been detected. For example, once two contacts (overlapping in time) have been detected, the first contact to move may be designated as the primary contact and a graphical element corresponding to a location of the primary contact may be selected and moved responsive to movement of the primary contact. Once the primary contact has been designated, continued presence of the secondary contact may or may not be required to complete the drag and drop move operation, and/or any “noise” movement of the secondary contact may be disregarded.

Embodiments of the present invention have been discussed above with respect to the touch-screen display 260 of FIG. 2B with integrated display screen and touch-sensitive interface. Embodiments of the present invention may also be implemented in electronic devices with separate display screens and touch-sensitive interfaces, such as in mobile terminal 200a of FIG. 2A. With separate display screen 210 and touch-sensitive interface 215, locations of contact on touch-sensitive interface 215 may be mapped by processor 140 to corresponding locations on display screen 210.

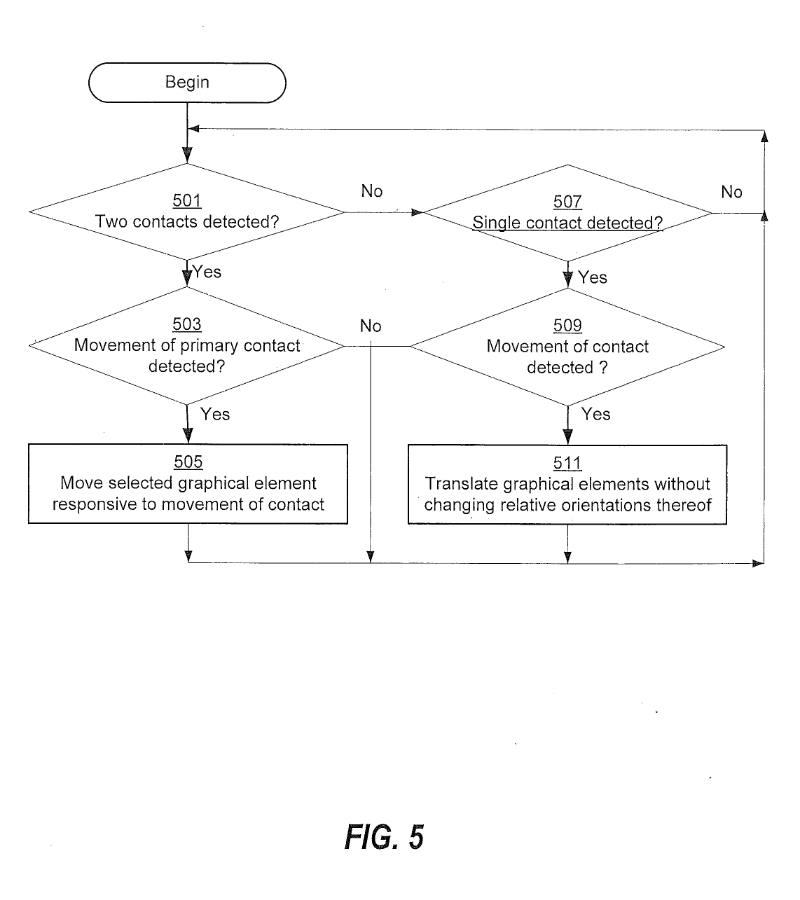

FIG. 5 is a flow chart illustrating operations of an electronic device 100 including a processor 140 and user interface 155 according to some embodiments of the present invention. Operations of FIG. 5 may be performed with a user interface including separate display screen and touch-sensitive interface as discussed above with respect to FIG. 2A, or with a user interface including integrated touch-sensitive interface 215 and display screen 210 providing a touch-screen display 260 as discussed above with respect to FIG. 2B.

If primary and secondary contacts are detected (overlapping in time) on the touch-sensitive interface at block 501, and movement of the primary contact on the touch-sensitive interface is detected at block 503, a graphical element presented on the display screen may be moved from a first location on the display screen to a second location on the display screen at block 505. More particularly, the graphical element may be moved so that a position of the graphical element changes relative to other graphical elements presented on the display screen. Detecting the primary contact may include detecting the primary contact at a first location on the touch-sensitive interface, detecting movement of the primary contact may include detecting movement of the primary contact from the first location on the touch-sensitive interface to a second location on the touch-sensitive interface, and the first and second locations on the display screen may respectively correspond to the first and second locations on the touch-sensitive interface.

The primary contact may be determined as the subsequent of two contacts overlapping in time, or the primary contact may be determined as the initial of two contacts overlapping in time. According to other embodiments, the primary and secondary contacts may be determined based on location on the touch-screen display, with a designated area being provided for the secondary contact so that order of initial contacts of time overlapping primary and secondary contacts does not matter. For example, a top, bottom, or side margin of the touch-screen display may be provided for the secondary contact used to identify a drag and drop move operation to be performed using a primary contact provided on a portion of the touch-screen display corresponding to the graphical element to be selected and moved. According to yet other embodiments, the primary contact may be determined as the first of the two contacts to move after the two time overlapping contacts have been detected. For example, once two time overlapping contacts have been detected, the first of the contacts to move may be designated as the primary contact and a graphical element corresponding to the primary contact may be selected and moved responsive to movement of the primary contact. Once the primary contact has been designated, continued presence of the secondary contact may or may not be required to complete the drag and drop move operation, and/or any “noise” movement of the secondary contact may be disregarded.

If two contacts are not detected at block 501, but a single contact is detected on the touch-sensitive interface at block 507 and movement of the single contact is detected at block 509, positions of a plurality of graphical elements presented on the display screen may be translated at block 511 without changing relative positions of the plurality of graphical elements presented on the display screen. Stated in other words, a scroll and/or pan operation may be preformed responsive to detecting a single contact. Accordingly, the electronic device may easily distinguish between drag and drop move operations requiring two time overlapping contacts on the touch-sensitive interface and a translation (e.g., scroll, pan, etc.) operation requiring only a single contact on the touch-sensitive interface.

Many variations and modifications can be made to embodiments of the present invention discussed above without substantially departing from the principles of the present invention. All such variations and modifications are intended to be included herein within the scope of the present invention, as set forth in the following claims.

That which is claimed:

1. A method of operating an electronic device including a touch-sensitive interface and a display screen, the method comprising:
detecting primary and secondary contacts on the touch-sensitive interface;
detecting movement of the primary contact on the touch-sensitive interface; and
responsive to detecting movement of the primary contact and detecting the secondary contact, moving a graphical element presented on the display screen from a first location on the display screen to a second location on the display screen.

2. A method according to claim 1 wherein the graphical element comprises a first graphical element of a group of graphical elements presented on the display screen, wherein moving the graphical element comprises changing a position of the first graphical element presented on the display screen relative to a second graphical element of the group presented on the display screen to change an order of the first and second graphical elements in the group.

3. A method according to claim 2 further comprising:
detecting a third contact on the touch-sensitive interface;
detecting movement of the third contact on the touch-sensitive interface without detecting other contact on the touch-sensitive interface; and
responsive to detecting movement of the third contact without detecting other contact on the touch-sensitive interface, translating positions of the group of graphical elements presented on the display screen without changing relative positions of the group of graphical elements presented on the display screen.

4. A method according to claim 2 wherein the group comprises a list, wherein the first and second graphical elements comprise first and second elements of the list, and wherein moving the first graphical element comprises changing an order of the first and second graphical elements in the list.

5. A method according to claim 2 wherein the group comprises a array, wherein the first and second graphical elements comprise first and second icons of the array, and wherein moving the first icon comprises changing an order of the first icon relative to the second icon in the array.

6. A method according to claim 1 wherein the touch-sensitive interface and the display screen are integrated to provide a touch-screen display.

7. A method according to claim 1 wherein detecting the primary contact comprises detecting the primary contact at a first location on the touch-sensitive interface, wherein detecting movement of the primary contact comprises detecting movement of the primary contact from the first location on the touch-sensitive interface to a second location on the touch-sensitive interface, and wherein the first and second locations on the display screen respectively correspond to the first and second locations on the touch-sensitive interface.

8. A method according to claim 1 wherein detecting the primary and secondary contacts comprises detecting contacts of respective primary and secondary input objects on the touch-sensitive interface.

9. A method according to claim 1 wherein moving the graphical element comprises moving the graphical element and preventing scrolling/panning responsive to detecting movement of the primary contact while detecting the secondary contact.

10. A method according to claim 1 wherein moving the graphical element comprises moving the graphical element responsive to detecting movement of the primary contact after detecting the primary and secondary contacts overlapping in time.

11. A method according to claim 1 wherein detecting the primary contact on the touch-sensitive interface precedes detecting the secondary contact on the touch-sensitive interface.

12. A method according to claim 1 wherein detecting the secondary contact on the touch-sensitive interface precedes detecting the primary contact on the touch-sensitive interface.

13. An electronic device comprising:
a touch-sensitive interface;
a display screen; and
a processor coupled to the touch-sensitive interface and to the display screen, wherein the processor is configured to detect primary and secondary contacts on the touch-sensitive interface, to detect movement of the primary contact on the touch-sensitive interface, and to move a graphical element presented on the display screen from a first location on the display screen to a second location on the display screen responsive to detecting movement of the primary contact and detecting the secondary contact.

14. An electronic device according to claim 13 wherein the graphical element comprises a first graphical element of a group of graphical elements presented on the display screen, wherein moving the graphical element comprises changing a position of the first graphical element presented on the display screen relative to a second graphical element of the group presented on the display screen to change an order of the first and second graphical elements in the group.

15. An electronic device according to claim 14 wherein the processor is further configured to detect a third contact on the touch-sensitive interface, to detect movement of the third contact on the touch-sensitive interface without detecting other contact on the touch-sensitive interface, and to translate positions of the group of graphical elements presented on the display screen without changing relative positions of the group of graphical elements presented on the display screen responsive to detecting movement of the third contact without detecting other contact on the touch-sensitive interface.

16. An electronic device according to claim 14 wherein the group comprises a list, wherein the first and second graphical elements comprise first and second elements of the list, and wherein moving the first graphical element comprises changing an order of the first and second graphical elements in the list.

17. An electronic device according to claim 14 wherein the group comprises a array, wherein the first and second graphical elements comprise first and second icons of the array, and wherein moving the first icon comprises changing an order of the first icon relative to the second icon in the array.

18. An electronic device according to claim 13 wherein detecting the primary contact comprises detecting the primary contact at a first location on the touch-sensitive interface, wherein detecting movement of the primary contact comprises detecting movement of the primary contact from the first location on the touch-sensitive interface to a second location on the touch-sensitive interface, and wherein the first and second locations on the display screen respectively correspond to the first and second locations on the touch-sensitive interface.

19. An electronic device according to claim 13 wherein moving the graphical element comprises moving the graphical element and preventing scrolling/panning responsive to detecting movement of the primary contact while detecting the secondary contact.

20. A computer program product for operating an electronic device including a touch-sensitive interface and a display screen, the computer program product comprising a computer readable storage medium having computer readable program code embodied in said medium, said computer readable program code comprising:
computer readable program code that, when executed, detects primary and secondary contacts on the touch-sensitive interface;
computer readable program code that, when executed, detects movement of the primary contact on the touch-sensitive interface; and
computer readable program code that, when executed, moves a graphical element presented on the display screen from a first location on the display screen to a second location on the display screen responsive to detecting movement of the primary contact and detecting the secondary contact.
